(19) United States
(12) Patent Application Publication
(10) Pub. No.: US 2006/0070371 A1
(43) Pub. Date: Apr. 6, 2006

(54) Electric dipole moment propulsion system

(76) Inventor: John Quincy St. Clair, San Juan, PR (US)

Correspondence Address: JOHN ST. CLAIR, 52 KINGS COURT, 4A, SAN JUAN, PR, 00911, US

(21) Appl. No.: 10/958,436

(22) Filed: Oct. 5, 2004

(51) Int. Cl. F03H 1/00

(52) U.S. Cl. 60/203.1

(57) ABSTRACT

A spacecraft propulsion system utilizing a rotating octagon of trapezoidal electrically charged flat panels to create an electric dipole moment that generates lift on the hull.

### BRIEF SUMMARY OF THE INVENTION

The invention is a spacecraft utilizing trapezoidal electrostatically charged flat plate panels which form a pyramidal hull. A panel contains three holes each of which produces a potential energy ellipsoidal bubble that creates an electric dipole moment. The rotation of the hull generates a magnetic moment and a magnetic field gradient in the vertical direction that produces a lift force on the spacecraft.

### BACKGROUND OF THE INVENTION

It is known from electrodynamics that a hole in a conducting plane forms a potential energy bubble. This bubble creates an electric dipole moment from which it is possible to develop a magnetic moment. A rotating tilted hull produces a velocity gradient that generates a magnetic field gradient in the vertical direction. This combination produces a lift force on the spacecraft. A very large potential energy bubble is produced provided that the hole protrudes out of the plate in an ellipsoidal shape. Furthermore, a double cladding, in which each layer around the hole has a different permittivity, confines the field to the outside of the hull for even better results.

The planar potential energy is created by a grid of electrically charged wires or rods running the length of each panel. A circular potential energy from each rod very quickly sums to form a flat sheet of energy which emerges from the hole to form the potential energy bubble.

### SUMMARY OF THE INVENTION

The invention relates to a spacecraft utilizing a rotating octagon of trapezoidal electrically charged flat plate panels to form a hull in the shape of a pyramid. Each panel has three protruding ellipsoidal bubbles that produce an electric dipole moment from a planar potential energy field created by a group of charged rods parallel to the panel. Because the panels are tilted and the hull is rotating, there is a tangential velocity gradient in the vertical direction. This creates the magnetic moment. Because the hull rotates, the radial electric field produces a magnetic field gradient in the vertical direction. This combination of magnetic moment and magnetic field gradient produces a lift force on the hull of the spacecraft.

On the underside of each panel is a group of high voltage electrically charged rods which run parallel to the panel. These wires or rods produce a planar electrical potential field underneath the holes in the panel. This potential energy field then bubbles out of the holes in the panel to create a large ellipsoidal potential energy field above the hull. The potential energy bubble carries an electric dipole moment which when rotated with the hull generates a magnetic moment in the vertical direction.

### A BRIEF DESCRIPTION OF THE DRAWINGS

FIG. 1. Perspective view of electric dipole moment spacecraft.

FIG. 2. Perspective exploded view of one panel with the ellipsoidal domes, flat hull panel with three holes, the charged rod grid and the planar potential energy field.

FIG. 3. Planar view of flat potential energy field produced by electrically charge wire rods.

FIG. 4. Perspective view of cylindrical coordinates {r, θ, z}.

FIG. 5. Perspective view of ellipsoidal potential energy field emerging from hole in plate which produces an electric dipole moment.

FIG. 6. Planar view of field lines of potential energy bubble emerging from plate hole.

FIG. 7. Planar view of sloping hull profile needed to get a velocity gradient.

FIG. 8. Perspective view of hull showing electric dipole moment, the tangential velocity of the hull, and the magnetic moment.

FIG. 9. Perspective view of the magnetic moment components in the radial and vertical direction whereby the lift force is generated by the dot product of the vertical magnetic moment with the magnetic field gradient.

FIG. 10. Perspective view of cross section of dome showing two layer cladding with different permittivities to enhance potential energy field.

FIG. 11. Planar view of enhanced potential energy field with two layer cladding.

### DETAILED DESCRIPTION OF THE INVENTION

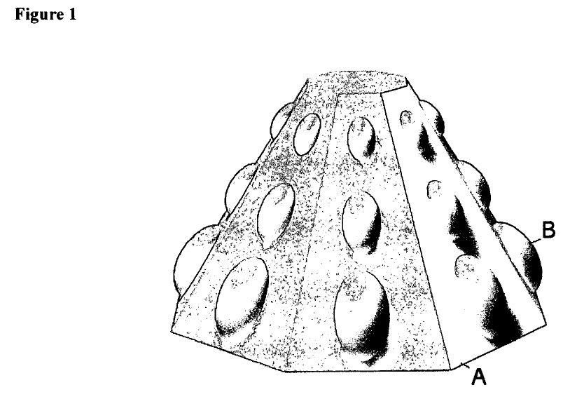

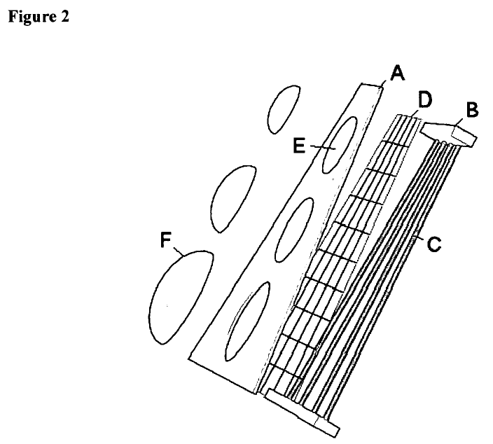

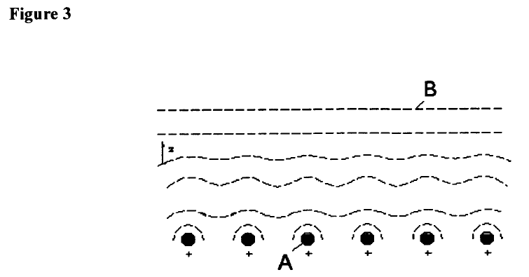

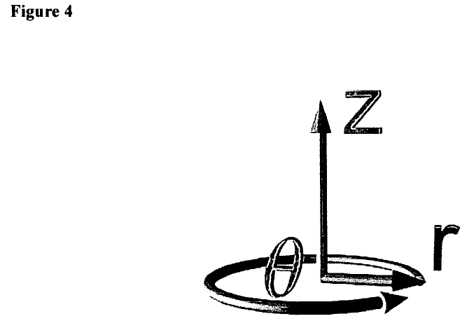

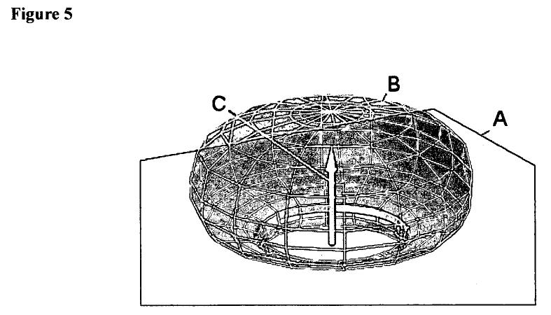

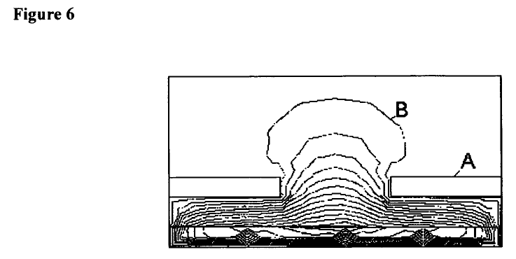

1. Referring to FIG. 1, the spacecraft is a rotating octagon of trapezoidal electrostatically charged flat panels which form a closed hull (A). Each panel has three ellipsoidal domes (B) of varying size centrally located along the major length of the panel. The purpose of the dome is to create a large ellipsoidal potential energy bubble over the hull which develops an electrical dipole moment. Because the hull is rotating, a magnetic moment is created in the vertical direction. A magnetic field gradient created by the rotating electric field on the hull in combination with the magnetic moment produces a lift force on the hull.
2. Referring to FIG. 2, the trapezoidal hull panel (A) contains three ellipsoidal holes (E). A group of wires or rods (C) running parallel to and just underneath the panel are electrically charged to a high voltage at the end terminals (B). The rods produce a planar potential energy field (D) just under the holes in the panel. The field emerges from the holes in the shape of an ellipsoidal bubble and is amplified by an ellipsoidal dome (F) on the outside of the hull.
3. Referring to FIG. 3, the group of parallel rods (A) are given a linear charge λ in units of charge per meter. The electric field E developed by the rod is the linear charge divided by the circumference of a circle of radius r around the wire times the permittivity ε of space. The analysis of this arrangement shows that within a few grid width spacings, the potential energy field φ due to the electric field E₀ has become planar (B) in the z-direction given by the equation
   φ=−E₀z
4. Referring to FIG. 4, the following analysis is done in cylindrical coordinates {r,θ,z}.
5. Referring to FIG. 5, the ellipsoidal potential energy (B) emerges through the hole in the panel plate (A). In doing so it creates an electrical dipole moment (C) shown by the arrow normal to the hole area.
6. Referring to FIG. 6, the bubble (B) emerges through plate (A).
7. Because the bubble has the shape of an ellipse, the centroid y of the bubble would be four thirds the radius a divided by π as given by

$${\overline{y}}_{ellipse} = \frac{4}{3} \frac{a}{π}$$
The electric dipole moment is then given as the charge q times the centroid y. The charge of the hole is equal to the permittivity E times the electric field E emerging from the hole times the area of the hole of radius a

$$q = {ɛ}_{0} E π {a}^{2} \frac{{coul}^{2}}{{m}^{2} newton} \frac{newton}{coul} {m}^{2} = coul = charge$$
8. The electric dipole moment p is the centroid y times the charge q

$$p = qy = {ɛ}_{0} E π {a}^{2} \frac{4}{3} \frac{a}{π} = \frac{4}{3} {ɛ}_{0} {Ea}^{2} coul \cdot meter$$
The electric dipole moment p times the hull velocity v is equal to a magnetic moment μ which is what creates the lift force on the hull
   μ=pv amp·m²
9. The rotating hull creates the electric dipole moment velocity so that the entire hull develops a magnetic moment. In tensor notation, the magnetic moment μ is in the vertical z-direction because there is a radial component of the electric dipole moment times the velocity. The velocity is the radius r in the radial direction times the angular velocity ω in the z-direction
   μ^{z}=pᵣx^{r}ω^{z}
10. The force F on the hull is the gradient of the dot product of the magnetic moment μ with the magnetic B field
   F=∇(μ·B)
11. By electrically charging the hull of the vehicle, a radial electric field is produced. By rotating the hull, the radial electric field changes with time. Thus Maxwell's equations will involve the curl of the magnetic field in the radial direction because the radial electric field is varying with time

$${( ∇ \times B )}_{r} = \frac{1}{{c}^{2}} \frac{\partial {E}_{r}}{\partial t}$$
12. The cross product involves the magnetic field in the theta direction which is zero

$$\frac{1}{r} \frac{\partial {B}_{z}}{\partial θ} - \frac{\partial {B}_{θ}}{\partial z} = \frac{1}{{c}^{2}} \frac{\partial {E}_{r}}{\partial t} = \frac{1}{r} \frac{\partial {B}_{z}}{\partial θ}$$

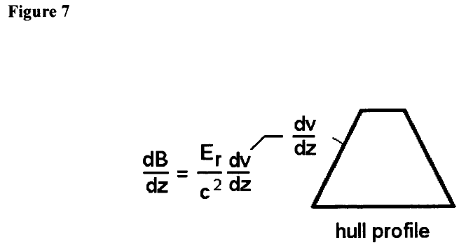

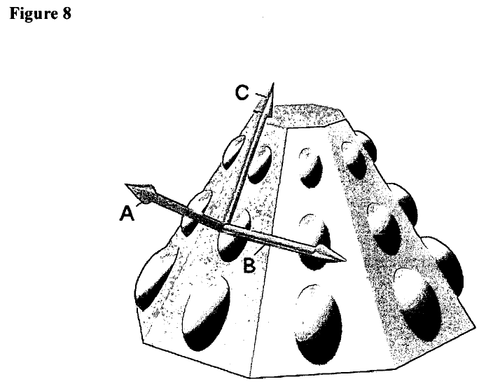

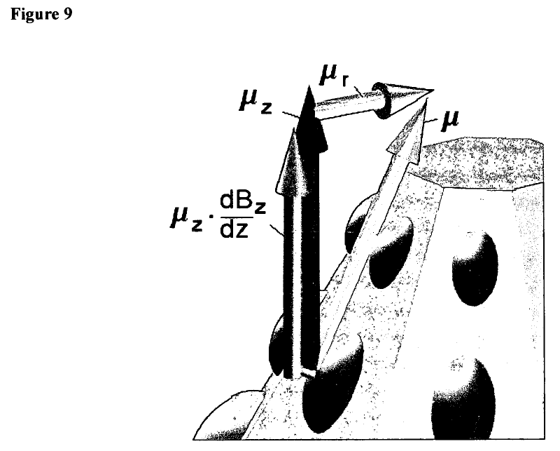

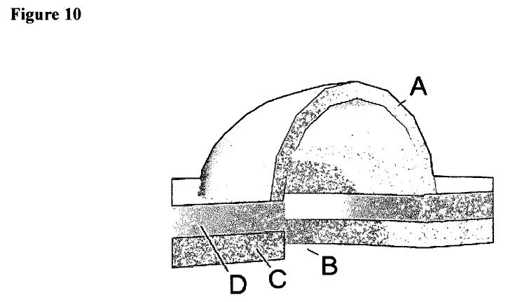

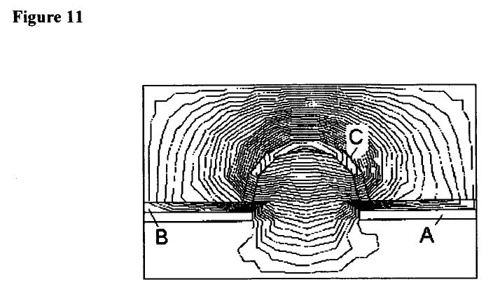

Substituting the derivative of the electric field E
   Eᵣ=E₀e^{iωt}
and integrating with respect to angle theta gives the vertical magnetic field B as the tangential velocity v times the radial electric field E divided by the speed of light c squared

$${B}_{z} = \frac{v}{{c}^{2}} {E}_{r}$$
13. The force on the hull is the gradient of the magnetic moment μ times the magnetic field B. In the equation for the magnetic field, the only available variable to work with in order to get a gradient of the magnetic field comes from the velocity.

$$\frac{ⅆ {B}_{z}}{ⅆ z} = \frac{{E}_{r}}{{c}^{2}} \frac{ⅆ v}{ⅆ z}$$
14. Referring to FIG. 7, because the hull is in the shape of a pyramid, the velocity is a function of the height z of the hull. Using eight flat sides keeps the radial electric field pointing in the same direction in each panel. Each panel has three domes to produce the magnetic moment for a total of 24 magnetic moment generators.
15. Referring to FIG. 8, the electric dipole moment (A) points in the radial direction, the rotating hull produces a tangential velocity (B), and the result is a magnetic moment (C) along the panel.
16. Referring to FIG. 9, because the magnetic moment is parallel to the panel, there are vertical and radial components of the magnetic moment. The vertical magnetic moment creates the dot product with the magnetic field gradient, which is equal to the lift force.
17. FIG. 10 shows a cross-section of the dome (A) and the plate hole (B) with double cladding to enhance the field. The upper cladding (D) has a low relative permittivity in the range of 2 to 40, and the lower layer has a high relative permittivity in the range of 1200 to 4000.
18. Comparing FIG. 11 to FIG. 7, this dome and cladding configuration creates a much larger electric dipole moment compared to a hole in the plate. The wavy lines are the equi-potential energy lines from the dome (C) and the upper layer (B) and the lower level (A).

I claim:

1. A spacecraft propulsion system comprising:
a rotating octagon of trapezoidal electrostatically charged flat panels which form a closed sloping hull in the shape of a pyramid;
panels each having three holes covered by three ellipsoidal domes of varying size centrally located along the major length and axis of each panel; and
a grid of high voltage electrostatically charged rods located on the interior side of each panel such that a planar potential field is produced parallel to and under each panel hole.

2. The domes, holes and rotating charged hull of method 1 producing:
an ellipsoidal potential energy field emerging from the holes and generating an electric dipole moment on the outside of the hull;
a magnetic moment in the vertical direction due to the rotating electric dipole moment; and
a rotating electric field in the radial direction which generates a corresponding magnetic field gradient in the vertical direction proportional to the velocity gradient of the sloping panels of the hull.

3. A lift force on the spacecraft hull generated by:
the magnetic moment times the gradient of the magnetic field in the vertical direction; and
a dual surface layer hull cladding having different permittivities which enhance the electric dipole moment whereby the upper cladding has a low relative permittivity in the range of 2 to 40, and the lower layer has a high relative permittivity in the range of 1200 to 4000.
